(19) United States
(12) Patent Application Publication
(10) Pub. No.: US 2022/0053806 A1
(43) Pub. Date: Feb. 24, 2022

(54) System and Method of Making a Banana Pudding

(71) Applicant: Kimberlyn Pettway, Irving, TX (US)

(72) Inventor: Kimberlyn Pettway, Irving, TX (US)

(21) Appl. No.: 17/408,313

(22) Filed: Aug. 20, 2021

Related U.S. Application Data
(60) Provisional application No. 63/068,283, filed on Aug. 20, 2020.

(51) Int. Cl. A23L 19/00

(52) U.S. Cl. CPC A23L 19/09; A23V 2002/00

(57) ABSTRACT

Disclosed is a system and a method of making a banana pudding.

The current application claims a priority to the U.S. provisional patent application Ser. No. 63/068,283 filed on Aug. 20, 2020.

### FIELD OF THE INVENTION

The present invention relates generally to food and desserts. More specifically, a proprietary variety of banana pudding.

### BACKGROUND OF THE INVENTION

Banana pudding is a dessert item generally consisting of layers of custard, cookies (e.g., Vanilla Wafers or ladyfingers) and sliced bananas, commonly topped with whipped cream. It is commonly prepared using a baked or refrigerated method. A typical method for making Banana pudding is to repeatedly layer the bananas, custard, and wafers into a dish and top with whipped cream or meringue

The present invention introduces a unique improvement to banana pudding, through the introduction of a variety of additional flavors and embodiments.

### BRIEF DESCRIPTION OF THE DRAWINGS

FIG. 1 is a photograph of the present invention.

FIG. 2 is a photograph of the present invention.

FIG. 3 is a photograph of the present invention.

FIG. 4 is a photograph of the present invention.

FIG. 5 is a photograph of the present invention.

FIG. 6 is a photograph of the present invention.

FIG. 7 is a photograph of the present invention.

FIG. 8 is a photograph of the present invention.

FIG. 9 is a photograph of the present invention.

FIG. 10 is a photograph of the present invention.

FIG. 11 is a photograph of the present invention.

### DETAILED DESCRIPTION OF THE INVENTION

All illustrations of the drawings are for the purpose of describing selected versions of the present invention and are not intended to limit the scope of the present invention.

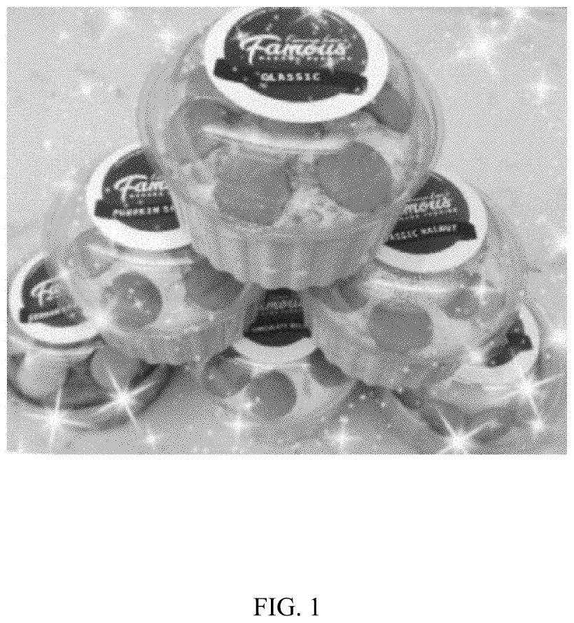

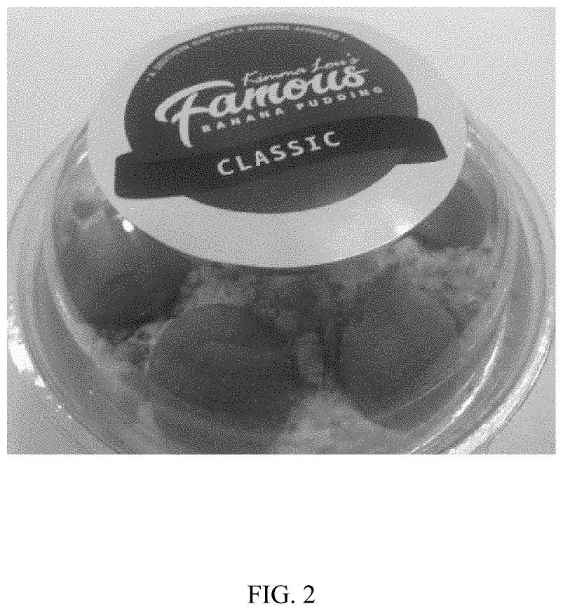

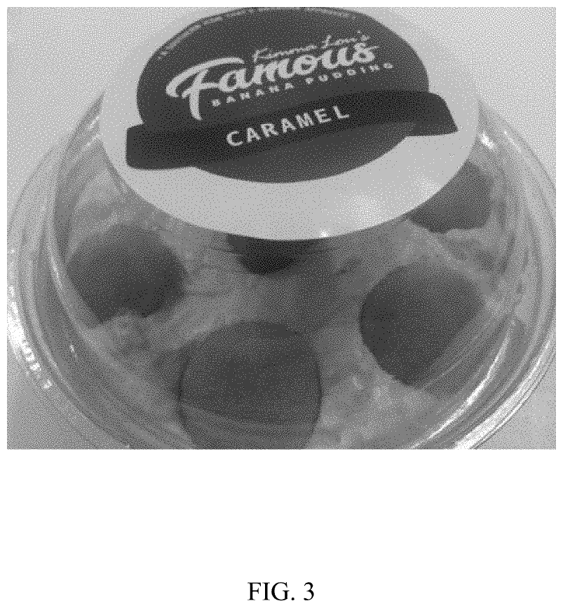

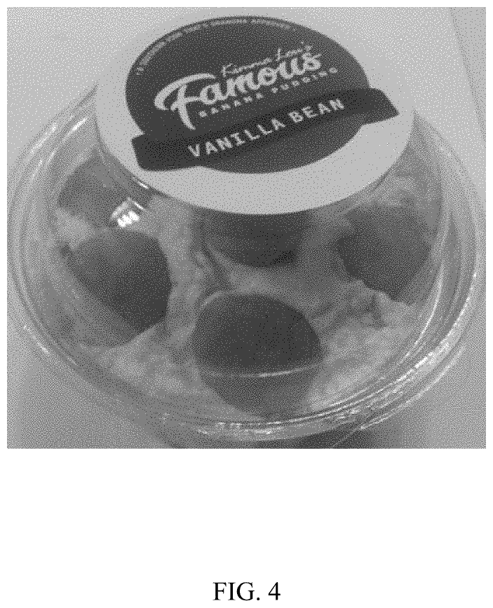

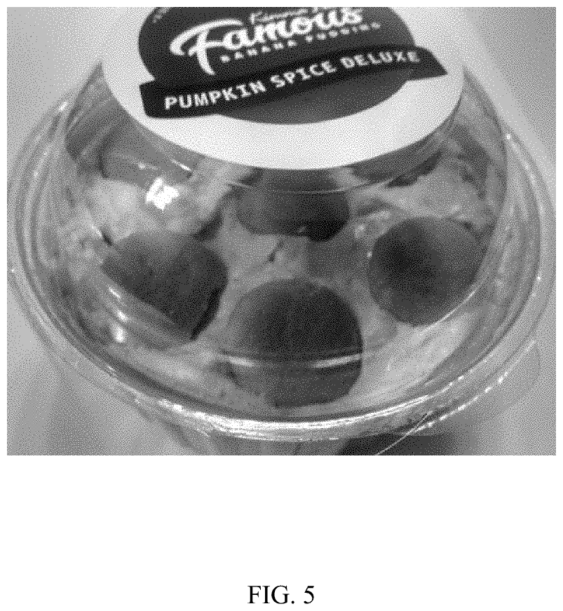

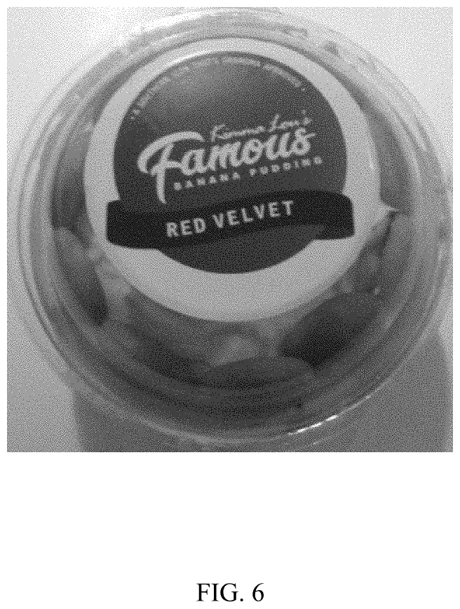

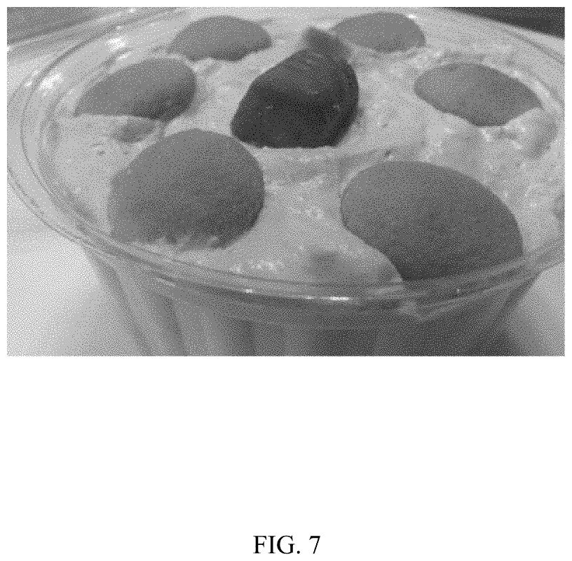

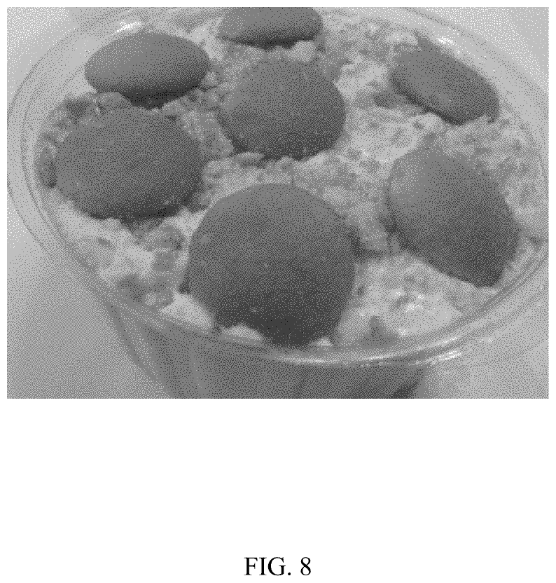

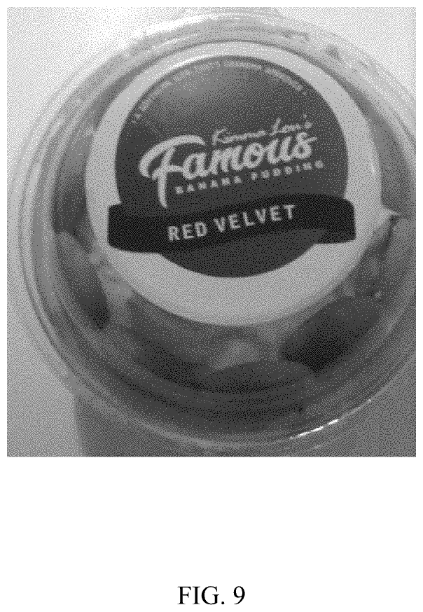

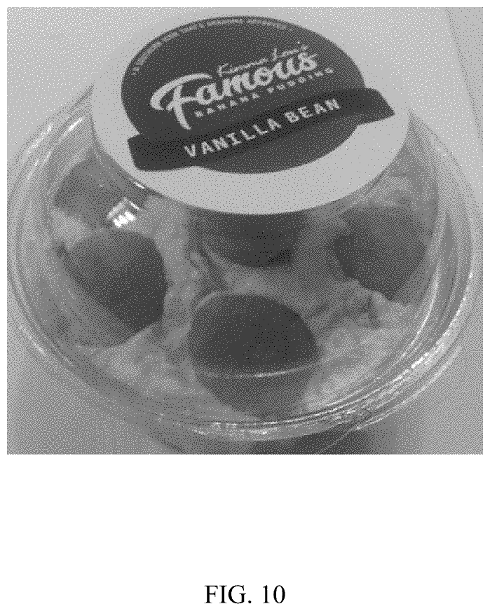

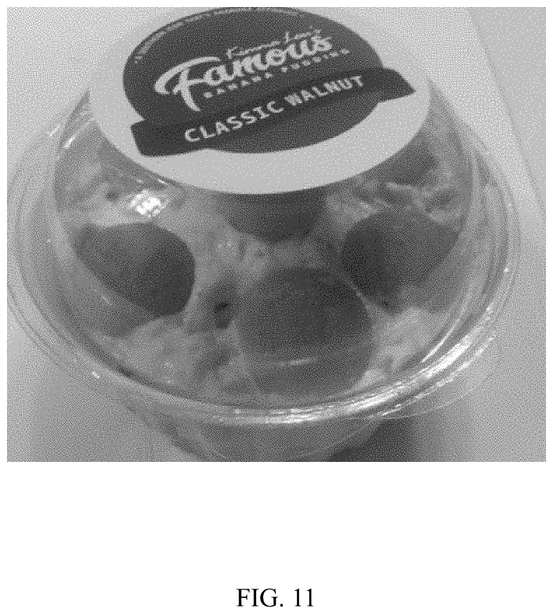

As can be seen in FIGS. 1 through 11, the present invention, herein referred to as “Kimma Lou's Famous Banana Pudding”, is a proprietary food product. Ingredients in the food or drink recipe are combined to create a desired characteristic of the end food product.

Kimma Lou's Famous Banana Pudding can come in a variety of embodiments incorporating flavors such as, but not limited to, Caramel, Classic, German Chocolate, Pumpkin Spice, Pumpkin Spice Deluxe, Red Velvet, Classic Walnut, White Chocolate and Vanilla Bean banana pudding.

Although the invention has been explained in relation to its preferred embodiment, it is to be understood that many other possible modifications and variations can be made without departing from the spirit and scope of the invention as hereinafter claimed.

What is claimed is:

1. A method of making a banana pudding, the method comprising the steps of:
selecting a specific flavor for a quantity of banana pudding, wherein the specific flavor is selected from a group consisting of: a classic flavor, a caramel flavor, a german-chocolate flavor, a pumpkin-spice flavor, a pumpkin-spice-deluxe flavor, a red-velvet flavor, a classic-walnut flavor, a white-chocolate flavor, and a vanilla-bean flavor; and
executing a recipe to make the specific flavor.
